(19) United States
(12) Patent Application Publication
(10) Pub. No.: US 2008/0201328 A1
(43) Pub. Date: Aug. 21, 2008

(54) Data Processing System and Method

(76) Inventors: Ana Cristina Benso Da Silva, Porto Alegre (BR); Ioao Batista Souza De Oliveira, Porto Alegre (BR); Felipe Rech Meneguzzi, Porto Alegre (BR); Leonardo Luceiro Meirelles, Porto Alegre (BR)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/587,066

(22) PCT Filed: Apr. 28, 2005
(86) PCT No.: PCT/US2005/014654

§ 371 Date: Feb. 5, 2008

(30) Foreign Application Priority Data
Apr. 30, 2004 (GB) 0409613.7

(51) Int. Cl. G06F 17/30; G06F 17/00

(52) U.S. Cl. 707/6; 707/100; 707/E17.001; 707/E17.012

(57) ABSTRACT

A system and method for grouping separate elements, having a common characteristic, to produce at least one of an output document corresponding to a presentation or for producing the presentation.

### FIELD OF THE INVENTION

The present invention relates to a data processing system and method and, more particularly, to a formatter system and method.

### BACKGROUND TO THE INVENTION

It is well known within the art that the Apache Software Foundation provides support for the Apache community of open source software projects. Apache projects are characterised by a collaborative, consensus based development process, an open and pragmatic software license, and a desire to create high quality software that leads the way in the field.

The Apache XML project, which forms part of the activities of the Apache Software Foundation, aims to provide commercial standard software-based XML solutions that are developed in an open and co-operative fashion, to provide feedback to standard bodies (such as IETF and W3C) from an implementation perspective and to be a focus for XML related activities within Apache projects.

One of the well-known Apache XML projects is the Formatting Objects Processor (FOP), which is a print or media formatter driven by XSL Formatting Objects (XSL-FO) to produce output-independent formatted documents. The Formatting Object Processor is a Java application that reads a formatting object tree and renders the result in pages in a specified output format. The currently supported output formats include PDF, PCL, PS, SVG, XML (Area tree representation), Print, AWT, MFI and TXT. However, one skilled in the art appreciates that the primary output target is PDF.

Those skilled in the art understand that the goals of the Apache XML FOP project are to deliver an XSL-FO to PDF formatter that is compliant to at least the basic conformance level described in the W3C recommendation from 15 Oct. 2001, and that complies with the 11 Mar. 1999 portable document format specification (version 1.3) from Adobe Systems Incorporated, both of which are incorporated herein by reference for all purposes.

XSL-FO is an XML vocabulary that is used to specify pagination and other styling for page layout output. The acronym “FO” stands for Formatting Objects. XSL-FO can be used in conjunction with XSL-Transformations (XSL-T) to convert any XML format document into paginated layout ready for printing or displaying. XSL-FO defines a set of elements in XML that describes the way pages are set up. The contents of the pages are filled from content flows, which are essentially non-paginated descriptions of document content. There can be static flows that appear on every page such as, for example, headers and footers and the main flow, which fills the body of the page. XSL-T describes the transformation of arbitrary XML into other XML (like XSL-FO), HTML or plain text for example.

Referring to FIG. 1, there is shown a process 100 for displaying or rendering XML. An XML document 102, that is, a document expressed using XML, can be displayed using an XML-enabled web browser 104, either alone or in conjunction with, for example, a CSS style sheet 106. Alternatively, and preferably, the XML document 102 can be displayed using an XSL display engine 108 preferably in conjunction with an XSLT style sheet 110. A still further option for displaying or rendering the XML document 102 is to produce, for example, an HTML document 112 using an XSL transformation 114, which processes both an XSL transformation specification 116 and the XML document 102. The resulting HTML document 112 can then be displayed using a conventional web browser 118.

However, FIG. 2 shows a preferred process 200 for producing a document from an XML source file 202. An XSL-T processor 204 in conjunction with an XSLT style sheet 206 processes the XML source file or document 202. The XSLT processor 204 produces an XSL-FO file 208, which is, in turn, processed by a formatting objects processor 210 to produce an output document 212. As mentioned above, the output document 212 can have many formats. However, a preferred format is the portable document format (PDF) as described above.

As mentioned above an XSL style sheet processor 204 accepts, as an input, XML data or an XML document 202 as well as an XSLT style sheet 206. The XSLT style sheet processor 204 produces a presentation or representation of that XML source content according to a designer's intention. The designer's intention is, of course, expressed in the XSLT style sheet 206. The production of the presentation of the XML source content has at least two steps or involves at least two processes. Firstly, a result tree is constructed from the XML source tree or document 202 and, secondly, the result tree is interpreted to produce formatted results suitable for presentation on an intended display device or intended media. It is well understood within the art that the first process is known as a tree transformation and the second process is known as formatting. Typically, a formatter such as the formatting objects process described above undertakes the process of formatting.

It will be appreciated that the structure of the result tree may well be significantly different to the structure of an XML source tree. This follows from the processing or layout guidance contained within the XSLT style sheet 206. Including formatting semantics within the result tree produces the format of an output document. These formatting semantics are, typically, expressed in terms of a catalogue of classes of formatting objects. Usually the nodes of the result tree correspond to or represent formatting objects. The various classes of formatting objects denote typographical abstractions such as, for example, page, paragraph, table etc as is well understood by those skilled in the art. The control of these abstractions is also provided in the form of formatting properties. The formatting properties can control aspects such as indents, word and letter spacing and widow, orphan and hyphenation control. Within XSL, the classes of formatting objects and the formatting properties provide a means for expressing presentation intent or intention.

An XSL style sheet is used in the first process, that is, the tree transformation. The style sheet contains a set of tree construction rules, which comprise two parts: namely, a pattern that is matched against elements of the source tree and a template that constructs a corresponding portion of the result tree using data associated with the matched pattern.

The process of formatting, which, as indicated above, is undertaken by a formatter, which interprets the results tree, in its formatting objects tree form, to produce a presentation that was intended by the designer of the style sheet from which the XML element and attribute tree in the “fo” name space was constructed.

As is well understood by those skilled in the art the vocabulary of formatting objects supported by XSL, that is, the set of “fo” element types, represents a set of typographical abstractions available to a layout designer. Each formatting object of the formatting element and attribute tree represents a specification of part of the pagination, layout and styling information that will be or will potentially be applied to the content of that formatting object as a result of formatting the whole result tree.

Formatting consists of the generation of a tree of geometric areas. Typically, those skilled in the art refer to such tree of geometric areas as the area tree. The geometric areas are positioned on a sequence of one or more pages. Any given geometric area has associated characteristic such as, for example, a position on a page, an indication or specification of the content to be displayed within that area and may also have further specified attributes or characteristics such as, for example, background, padding and borders. As an example, formatting a single character generates an area of sufficient size to hold the glyph that is used to represent the character visually. The glyph is displayed in that area. It is well understood by those skilled in the art that geometric areas can be nested. Therefore, for example, a glyph may be positioned within a line, within a block, or within a page.

The process of rendering or producing the presentation intended by the designer takes the area tree, that is, the abstract model of the presentation expressed in terms of pages and their respective collections of areas, and causes the presentation to appear on or within a selected medium or in a format suitable for a selected medium. The selected medium can be, for example, a browser window on a computer screen or sheets of paper or other appropriate medium. The first step of formatting is to objectify the elements and attribute tree obtained by the XSL-T transformation. Objectification of the result tree comprises turning the elements of the tree into formatting object nodes and the corresponding attributes of the result tree into property specifications. This step creates what is known within the art as the formatting object tree.

A second phase of formatting comprises refining the formatted object tree to produce a refined formatting object tree. The refinement process addresses the mapping of properties and traits. This comprises (1) shorthand expansion into individual properties, (2) mapping of corresponding properties, (3) determining computed values, which, itself, may comprise expression evaluation, (4) handling white-space treatment and line-feed treatment property effects, and (5) inheritance.

A third step in formatting is the construction of the area tree. The area tree is generated as described in the semantics of each formatting object. The traits applicable to the formatting object class control how the areas are generated. Referring to FIG. 3, there is shown a summary of the process 300 of generating an area tree. An element of the result XML tree in the “fo” name space 302, together with its associated attributes 304 are objectified to produce a formatting object element 306 with associated properties 308, where appropriate. The formatting object element 306 is subjected to the refinement process in which the formatting object element 306 and the associated properties 308 are processed to produce a formatting object element 310 also having associated traits 312. The formatting element 310 and the associated traits 312 are used in an area generation process to produce an area 314 bearing corresponding traits 316 that were dictated by the traits 312 of the refined formatting object element 310. It can be appreciated from the example of the traits that the area, that is, the block-area 314, will be arranged to have an indent that starts at a position of 40 points and uses a font size of 20 points.

As indicated above, formatting is the process of turning the formatting objects tree into a tangible form suitable for output via an appropriate medium or mechanism such as, for example, printing on paper or output via an audio or visual device. Typically formatting involves the construction of an area tree, that is, an audit tree containing geometric information associated with the placement or positioning of every glyph, shape etc in the document in conjunction with information, known as traits, describing associated spacing and other rendering constraints.

Formatting objects are elements in the formatting object tree, whose names are taken from the XSL name space. A formatting object belongs to a class of formatting objects identified by its element name. The behaviour of each class of formatting objects is described in terms of the respective areas created by the formatting object of that class as well as how the traits of the areas are established and how the areas are hierarchically structured with respect to areas created by other formatting objects. Some formatting objects are, for example, block-level and others are inline-level, which refer to the types of areas the respective formatting objects generate. This, in turn, refers to the default placement level. Inline areas such as, for example, glyph-areas, are collected into lines and the direction in which they are stacked is known as the inline-progression-direction.

There will now be described, for the sake of completeness, an area model. In XSL, the tree of formatting objects serves as an input or specification to be processed by the formatter, that is, the formatting objects processor. The formatter generates a hierarchical arrangement of areas, which comprise the formatted result.

In general, the formatter produces an area tree that describes or illustrates the relative geometric structuring of the output medium. The structure of the tree can be described in terms of child, sibling, parent, descendant and ancestors. Each area tree has an initial or root node. Each area tree node other than the root is called an area. It is associated with a rectangular portion of the output medium. It will be appreciated by those skilled in the art that areas are not formatting objects and that a formatting object generates zero or more rectangular areas and, normally, each area is generated by the unique object in the formatting object tree.

The hierarchical structure 400 of an area is schematically illustrated in FIG. 4. It can be appreciated from FIG. 4 that an area has a content rectangle 402, which is the portion to which its child areas, if any, are assigned or within which they are effective. An area also has an optional padding rectangle 404 as well as an optional border rectangle 406. It is well known within the art that the outer bound of the border is called the border-rectangle and the outer bound of the padding is known as the padding-rectangle. The various areas or each area have or has a respective set of traits, that is, a mapping of names to values, in a similar way to which elements have attributes and formatting objects have properties. Individual traits are used for either rendering the area or for defining constraints on the result of formatting or both. Traits that are used only for formatting purposes or for defining constraints are known as formatting traits whereas traits that are used for rendering are known as rendering traits. As usual within the art, one skilled in the art understands that the semantics of each type of formatting object that generates areas is given in terms of which areas it generates and their place in the area tree hierarchy. This may be modified by interactions between the various types of formatting objects. The properties of the formatting object determine what areas are generated and how the formatting object's content is distributed among them.

The traits of an area are either: directly derived, that is, the values of directly-derived traits are the computed values of a property of the same or a corresponding name of the generating format object, or indirectly-derived, that is, the values of indirectly-derived traits are the results of a computation involving the computed values of one or more properties of the generating formatting object, the other traits on this area or other interacting areas (ancestors, parents, siblings and children) and/or one or more values constructed by the formatter.

As indicated above, there are two types of area; namely, block-areas and inline-areas. These areas differ according to how they are processed or stacked by the formatter. An area can have block-area children or inline-area children according to the properties or characteristics of the generating formatting object. However, the children of any given area must all be of the same type. The line-area is a special kind of block-area whose children are all inline-areas. A glyph-area is a special kind of inline-area that has no child areas and bears only a single glyph image as its content. Examples of areas are a paragraph rendered using an fo:block formatting object, which generates block-areas, and a character rendered using an fo:character formatting object, which generates an Inline area.

An area has two associated directions that are derived from the generating formatting object's writing-mode and reference-orientation properties. The block-progression-direction is the direction for stacking block area descendants of an area and the inline-progression-direction is the direction for stacking inline-area descendants of that area. A further trait, known as the shift-direction, applies to inline-areas and refers to the direction in which base line shifts are applied as is well known by those skilled in the art. Furthermore, a trait known as the glyph-orientation defines the orientation of glyph images in the rendered results.

Each area has a trait top-position, bottom-position, left-position and right-position which respectively represent the distances from the edge of its content-rectangle to the correspondingly named edges of the nearest ancestor reference area (or page view-port-area in the case of areas generated by descendants or objects whose absolute-position is fixed). Traits known as the left-offset and the top-offset determine the amount by which a relatively positioned area is shifted for rendering. These traits receive their values during the formatting process or, in the case of absolutely positioned areas, during refinement.

Traits known as the block-progression-dimension and the inline-progression-dimension of an area represent the extent of the content-rectangle in each of the relative dimensions. For completeness, other traits include the following: the is-first and is-last traits are Boolean traits indicating the order in which areas are generated and returned by a given formatting object. The amount of space outside the border-rectangle can be defined using the space-before, space-after, space-start and space-end traits. The thickness of each of the four sides of the padding is governed by the padding-before, padding-after, padding-start and padding-end traits. The style, thickness and colour of each of the four sides of the border are similarly governed by the following traits: border-before, border-after, border-start and border-end. The background rendering of any area is controlled by background-colour and background-image traits amongst others. A nominal-font trait for an area is determined by the font properties and character descendants of the area's generating formatting object.

Referring to FIG. 5 there is illustrated, in greater detail, a block area 500 comprising a content rectangle 502, a padding rectangle 504 and a border rectangle 506. The spacing or positioning relationship between the content rectangle 502 and the padding rectangle 504 is clearly illustrated by the traits padding-start, padding-end, padding-before and padding-after. The position or relationship between the border rectangle 506 and the padding rectangle 504 is illustrated by the traits border-start, border-end, border-before and border-after. The relationship between the border rectangle 506 and the block area 500 is governed by the traits space-start, space-end, space-before and space-after. Further traits, start-indent and end-indent define the position of the content 502 rectangle relative to the edges of the block area 500.

A line area is a special type of block area that is generated by the same formatting object that generated its parent area. As is well known by those skilled in the art, line areas do not have border and padding. Inline-areas are stacked within a line-area relative to a base line start point as indicated by the trait base line-start-point, which is a point determined by the formatter on the start-edge of the content rectangle of the line area.

As is well known within the art, the W3C organisation has produced a scaleable vector graphics standard, SVG 1.1, which is a modularised language for describing 2-dimensional vector and mixed vector/raster graphics in XML. The standard is incorporated herein by reference for all purposes.

For example, the following XSL-FO document

<fo:root xmlns:fo=“http://www.w3.org/1999/XSL/Format”>

<fo:layout-master-set>

<fo:simple-page-master master-name=“main”

margin-top=“36pt” margin-bottom=“36pt”
page-width=“8.5in” page-height=“11in”
margin-left=“72pt” margin-right=“72pt”>
<fo:region-body margin-bottom=“50pt”
margin-top=“50pt”/>

</fo:simple-page-master>

</fo:layout-master-set>
<fo:page-sequence master-reference=“main”>

<fo:flow flow-name=“xsl-region-body”>

<fo:block font-size=“14pt” line-height=“17pt”>

Like most Open Source projects,

<fo:inline
font-style=“italic”>AbiWord</fo:inline>

started as a cathedral, but has become more like a bazaar.

</fo:block>

</fo:flow>

</fo:page-sequence>

</fo:root>

produces the output “Like most Open Sourced project, Abiword started as a cathedral, but has become more like a bazaar”, is processed by Apache's formatting objects processor to produce the following document:

<svg:svg width=“451.275pt” height=“697.889pt”
xmlns:svg=“http://www.w3.org/2000/svg”>

<text x=“0.0” y=“9.816” style=“font-family:Times”>

Like

</text>

<text x=“24.996” y=“9.816” style=“font-family:Times”>

most

</text>

<text x=“51.336” y=“9.816” style=“font-family:Times”>

Open

</text>

<text x=“80.328” y=“9.816” style=“font-family:Times”>

Source

</text>

<text x=“116.652” y=“9.816” style=“font-family:Times”>

projects,

</text>

<text x=“160.644” y=“9.816”
style=“font-family:Times;font-style:italic”>

AbiWord

</text>

<text x=“208.968” y=“9.816” style=“font-family:Times”>

started

</text>

<text x=“243.96” y=“9.816” style=“font-family:Times”>

as

</text>

<text x=“256.956” y=“9.816” style=“font-family:Times”>

a

</text>

<text x=“265.284” y=“9.816” style=“font-family:Times”>

cathedral,

</text>

<text x=“315.264” y=“9.816” style=“font-family:Times”>

but

</text>

<text x=“333.6” y=“9.816” style=“font-family:Times”>

has

<text>

<text x=“352.596” y=“9.816” style=“font-family:Times”>

become

</text>

<text x=“392.916” y=“9.816” style=“font-family:Times”>

more

<text>

<text x=“420.576” y=“9.816” style=“font-family:Times”>

like

</text>

<text x=“441.576” y=“9.816” style=“font-family:Times”>

a

</text>

<text x=“0.0” y=“23.316” style=“font-family:Times”>

bazaar.

<text>

</svg:svg>

It will be appreciated by one skilled in the art that when processing an XSL-FO file to create SVG output using Apache's formatting object processor, the resulting SVG file is surprisingly significantly greater than anticipated. The formatting objects processor generates an XML tag for every XSL-FO object encountered. It will be appreciated that generating, for example, one SVG text object per word or line of text expressed within the XSL-FO file, even when a number of lines share the same attributes, adds a significant overhead to an SVG representation of such lines of text. Such behaviour is the result of the way in which FOP generates the Area Tree, and how the SVG generating module in FOP uses it to write the resulting SVG. Suitably, embodiments of the present invention provide a method for grouping flow or attributes of substantially similar or identical mark up elements such as, for example, XML tags.

It is an object of embodiments of the present invention to at least mitigate some of the problems of the prior art.

### SUMMARY OF INVENTION

Accordingly, a first aspect of embodiments of the present invention provides A method for processing an input document, comprising a plurality of separate entities having a common characteristic to produce an output document having a predeterminable format; the method comprising the steps of identifying within the input document the plurality of entities having the common characteristic identified by a respective characteristic identifier and creating an output entity in the output document comprising data associated with or derived from the plurality of entities; the output entity having a characteristic determined by the respective characteristic identifiers. In preferred embodiments, the plurality of separate entities comprises a plurality of lines of text or line objects. In preferred embodiments, the common characteristic comprises at least one of font style, font size, character spacing etc.

Preferably, embodiments provide a method in which the plurality of entities comprises a plurality of formatting objects such as, for example, a plurality of at least one of elements and attributes or formatting object blocks and properties (as, for example, when formatting objects before refinement) or formatting blocks and traits (as, for example, when formatting objects after refinement).

Embodiments provide a method in which the input document is, or is at least associated with or derived from, at least one of an XML document, a XSLT style sheet document and an XSL-FO document.

Embodiment provide a method in which the output entities are PDF elements or XML elements or elements of a document governed by a standard.

Preferred embodiments provide a formatting method comprising the steps of converting an XML document into a XSL-FO document using a corresponding XSL style sheet to produce a result tree; processing the result tree to produce an output document; the step of processing comprising the steps of grouping a series lines of text within an element of the output document to such effect that the common element contains a flow comprising the series of lines having a common characteristic.

Embodiments provide a method of formatting an output document according to a predeterminable format; the method comprising the steps of:
a. identifying, within a current XSL-FO area tree, or refined XSL-FO area tree, a current line area, corresponding to a current line object, of a current block area, corresponding to a current block object of the area tree;
b. determining a characteristic associated with the current line area (such as, for example, checking the properties 308 or traits 312 or the XSL-FO area tree or the refined XSL-FO area tree);
c. matching the characteristic with a common characteristic at least one or more consecutive line areas;
d. creating a group block area comprising the current line area and at least one or more consecutive line areas such that lines of text, derived from the current line area and at least one or more consecutive line areas, constituting the group block area possess the common characteristic to produce at least an output document area.

Embodiments provide a method further comprising the step of rendering the or a current output document area. It will be appreciated that the output can be rendered on the fly, that is, as the embodiment complete the grouping of associated lines of text or once the complete output document has been produced.

Preferred embodiments provide a method in which the common characteristic is at least one of a common XML or XML-FO element (such as <text> . . . </text>), an XML or XML-FO attribute-value pair such as, for example, style=“font-family:Times”, property or trait.

It will be appreciated that embodiment of the present invention can be implemented using a general-purpose computer. Suitably, embodiments provide a system comprising means to implement a method as claimed or described herein.

Preferred embodiments provide a computer program comprising computer code to implement such a method or system as claimed or described herein. Further embodiments provide a computer readable product comprising storage storing such a computer program. It will be appreciated that the computer program can be stored on computer readable storage such as, for example, an optical or magnetic disc, or in a memory device such as, for example, a chip, ROM, EPROM, flash memory or other device.

### BRIEF DESCRIPTION OF THE DRAWINGS

Embodiments of the present invention will now be described, by way of example only, with reference to the accompanying drawings in which:

FIG. 1 shows schematically process for producing an output document;

FIG. 2 illustrates schematically a further process for producing an output document;

FIG. 3 depicts a still further process for producing an output document;

FIG. 4 shows schematically a hierarchical structure of a mark-up entity;

FIG. 5 depicts schematically the hierarchical structure of the mark-up entity in greater detail; and

FIG. 6 illustrates a flowchart according to an embodiment of the present invention.

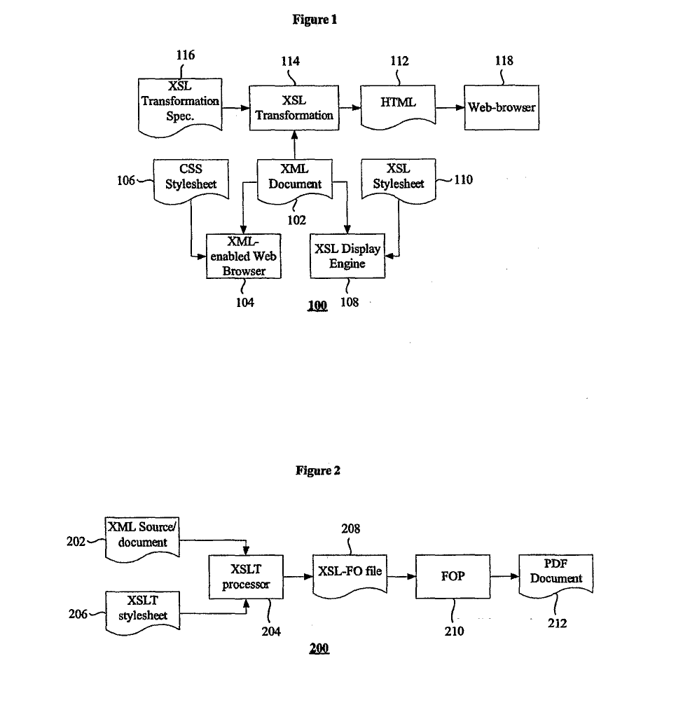

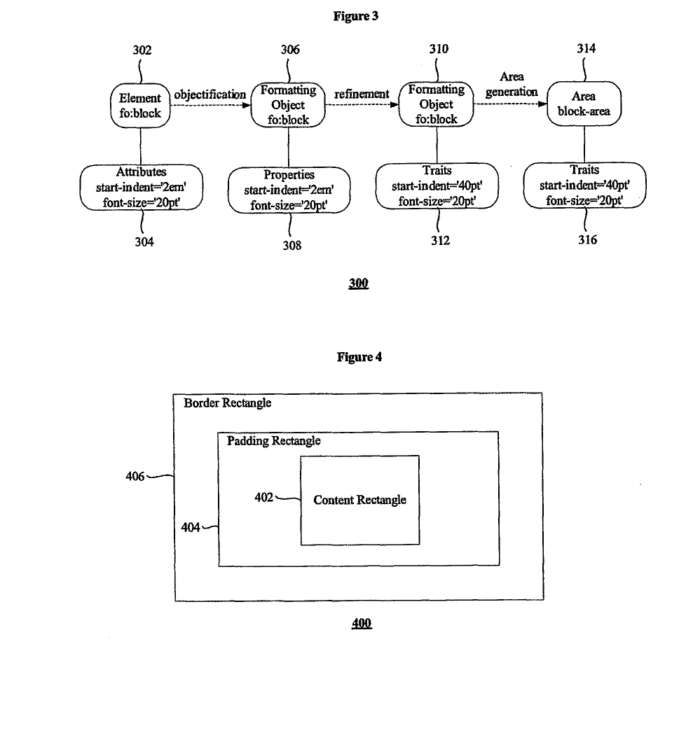

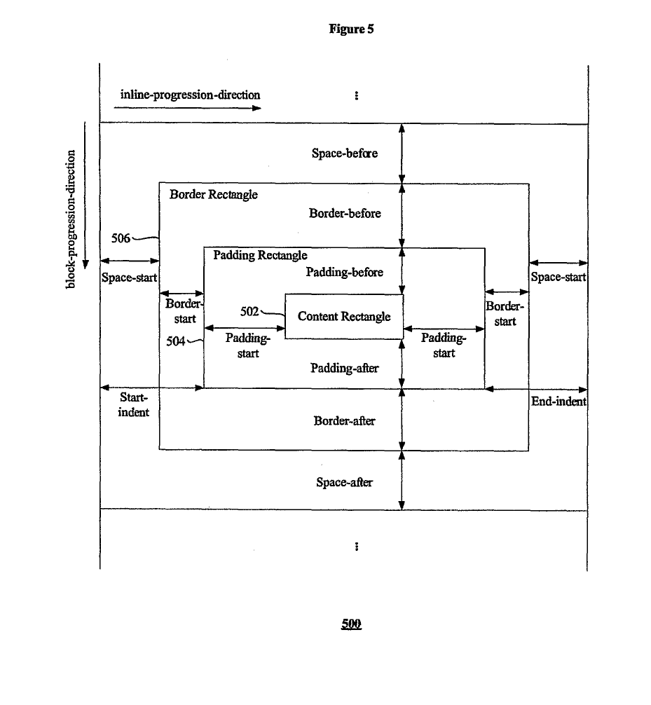

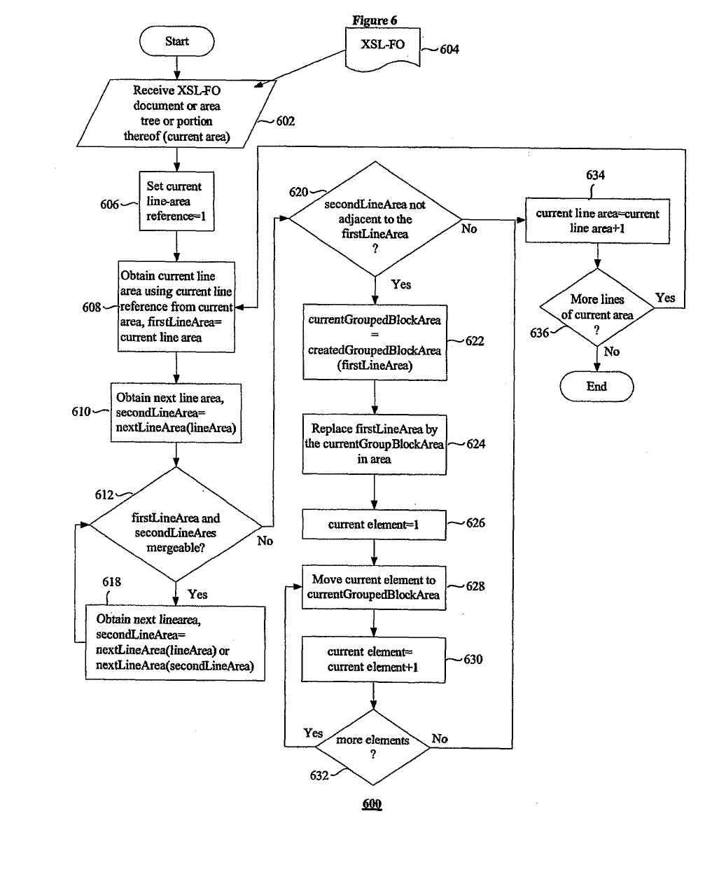

### DETAILED DESCRIPTION OF PREFERRED EMBODIMENTS

In preferred embodiments, content, corresponding to or derived from a respective <FO:flow> element or, more particularly, a plurality of such elements are made to correspond to a single respective element or XML tag. Advantageously, embodiments of the present invention produce the following document:

<svg:svg width=“451.275pt” height=“697.889pt”
xmlns:svg=“http://www.w3.org/2000/svg”>

<text x=“0.0” y=“9.816” style=“font-family:Times”>

Like most Open Source projects, </text>

<text x=“160.644” y=“9.816”
style=“font-family:Times;font-style:italic”>

AbiWord

</text>
<text x=“206.976” y=“9.816” style=“font-family:Times”>

started as a cathedral, but has become more like a

</text>
<g style=“font-family:Times”>

<text x=“0.0” y=“23.316”>

bazaar

</text>

</g>

</svg:svg>

from the above XSL-FO document. It can be appreciated that the document produced according to embodiments of the present invention are significantly smaller and more compact that documents produced by current FOPs. In essence, line areas have compatible characteristics are grouped, which allows a saving in the number of tags and associated attributes to be realised.

It can be appreciated that the content “Like most open source projects, Abiword started as a cathedral, but has become a bazaar”, rather than each line or line object being included with a respective <text . . . > XML tag, has been merged together to avoid the need to use so many <text> . . . </text> elements. It will be appreciated that this results in a significantly reduced file size and a potentially reduced processing overhead when rendering or transmitting the SVG document.

Embodiments of the present invention group objects whose attributes are the same into lines within the same Text object so that a single, for example, SVG Text object, comprising a number of words, can be generated in the output instead of one object per word. Areas relate to objects such as character, viewport, inline-container, a leader and space. A special inline area Word is also used for a group of consecutive characters.

An embodiment of the present invention can be summarised by the following algorithm:

1. Receive an XSL-FO Area Tree containing text objects;

2. For every Line Area LA1 in the Area Tree
A) Get nextLineArea LA2 in the Area Tree;
B) While LA1 is mergeable with LA2
   (i) Store next Line Area is LA2
C) If LA1 Is not the next one to LA2
   (i) Create a grouped block area holding LA1;
   (ii) Replace LA1 in the Area Tree for the Grouped Block Area.
   (iii) For every Line Area LAGroup between LA1 and LA2;
      (a) Move LAGroup to the Grouped Block Area;

3. Send the Area Tree to the renderer

4. For every Grouped BlockArea in the Area Tree
A) Create an svg:g object
B) Render every object within the Grouped Block Area omitting the attributes specified in the svg:g

The “mergeable” condition checks three types of attributes. The first group regards font styles, the second one regards text colors, and the third one references other elements. These groups are summarized below:

Font styles
Font name
Font size
Font weight
Font family
Font style
Font variant
Letter spacing

Colors
Red
Green
Blue

Text styles
Overline
Linethrough
Underline

It will be appreciated by one skilled in the art that pseudocode of various aspects of embodiments of the present invention is provided in Tables 1 and 2 below. Each pseudo-code aspect comprises an algorithm heading such as, for example, “Algorithm 1 LineMerging”, which provides an indication, in broad terms, of the function of the algorithm, a “Requires” heading, which provides an indication of the requirements of, or parameters used by, the algorithm and an “Ensures” heading, which provides an indication of the function performed by the algorithm.

TABLE 1
Algorithm 1 LineMerging
Requires: AreaTree (area) such that AreaTree contains text LineAreas
Ensures: LineAreas will have chunks of text merged within currentGroupBlockArea
for all lineArea ε area do
firstLineArea = lineArea
secondLineArea=nextLineArea(lineArea)

while mergeableLineAreas(firstLineArea, secondLineArea) do

secondLineArea=nextLineArea(lineArea)

endwhile
if secondLineArea is not the next one to firstLineArea then

currentGroupedBlockArea=(createGroupedBlockArea(firstLineArea))
replace firstLineArea by currentGroupedBlockArea in area
for all elements ε area between firstLineArea and secondLineArea do

move from area to currentGroupedBlockArea

end for

end if

end for

TABLE 2
Algorithm 2 MergeLineAreas
Require: inline
Require: firstLineArea ≠NULL and secondLineArea ≠NULL
Ensure: firstLineArea has the same attribute values as secondLineArea
for all attribute ∈ firstLineArea do

if attribute in firstLineArea does not match attribute in
secondLineArea then

return false

end if

end for
return true

Referring to FIG. 6, there is shown a flowchart 600 illustrating the processing performed by preferred embodiments of the present invention.

At step 602, an XSL-FO document 604 is received, or an area of an area tree is received (current area). At step 606, a reference for accessing or addressing the line areas or line objects of the received access to-FO document 604 is initialised. It can be appreciated that the reference is initialised to 1 in the illustrated embodiment. A current line area or line objects, firstLineArea, is retrieved or referenced from or in the current area at step 608. The next line area of the current area, secondLineArea, is retrieved at step 610.

Next, the embodiments of the present invention in determining, in effect, the start and end points of a block of line areas that have common attributes. Therefore, a determination is made, at step 612, as to whether not the firstLineArea and the secondLineArea can be merged.

If the determination is that the firstLineArea and the secondLineArea can be merged, the next line area is retrieved from the current area at step 614 and processing returns to step 612. However, if the determination at step 612 is negative, processing passes to step 620, where a determination is made as to whether not the firstLineArea and the secondLineArea are adjacent to one another.

If the determination at step 620 is positive, a current grouped block area, currentGroupedBlockArea, is set to equal of the firstLineArea at step 622. At step 624, the first line area of the current area is replaced by the currentGroupedBlockArea.

A current element variable, used as a reference for the elements of the current area, is initialized to 1, at step 626. A currently referenced element of the current area, determined from the current element variable, is moved into the currentGroupedBlockArea at step 628. The value of the current element variable is incremented to point to the next element of the current area at step 630. A determination is made at step 632 as to whether not there are further elements between the firstLineArea and the secondLineArea to be copied to the currentGroupedBlockArea. If the determination at step 632 is positive, processing resumes from step 628 where the next element of the current area is copied to the current grouped block area. However, if the determination at step 632 is negative, the reference for accessing or retrieving the line areas of the current area is incremented to point to the next line area, if any, at step 634. A determination is made, at step 636, as to whether or not the current area has further line areas to be processed. If the determination is positive, processing resumes from step 608, where the line area referenced by the current line area referenced is retrieved for further processing. If the determination at step 636 is negative, the grouping of line areas with common attributes is deemed to be completed.

Once the grouping of line areas with common attributes has been completed for all areas of a current area tree, in preferred embodiments, the resulting XSL-FO document is forwarded to the formatting objects processing for rendering. Alternatively, once a current area of an area tree has been processed according to embodiments of the present invention, the processed area can be output for rendering by the FOP.

It will be appreciated that embodiments of the present invention can be implemented using software in conjunction with a general-purpose computer. Furthermore, embodiments of the present invention can be realised in the form of a computer program, that is, software stored in, or on, a storage medium such as, for example, a memory device or card, magnetically or optically readable disc.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings) and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A method for processing an input document, comprising a plurality of separate entities having a common characteristic to produce an output document having a predeterminable format; the method comprising the steps of identifying within the input document the plurality of entities having the common characteristic identified by a respective characteristic identifier and creating an output entity in the output document comprising data associated with or derived from the plurality of entities; the output entity having a characteristic determined by the respective characteristic identifiers.

2. A method as claimed in claim 1 in which the plurality of entities comprises a plurality of formatting objects such as, for example, a plurality of at least one of elements and attributes or formatting object blocks and properties or formatting blocks and traits.

3. A method as claimed in claim 1 in which the input document is, or is at least associated with or derived from, at least one of an XML document, a XSLT style sheet document and an XSL-FO document.

4. A method as claimed in claim 1 in which the output entities are PDF elements or XML elements or elements of a document governed by a standard.

5. A formatting method comprising the steps of converting an XML document into a XSL-FO document using a corresponding XSL style sheet to produce a result tree; processing the result tree to produce an output document; the step of processing comprising the steps of grouping a series lines of text within an element of the output document to such effect that the common element contains a flow comprising the series of lines having a common characteristic.

6. A method of formatting an output document according to a predeterminable format; the method comprising the steps of:
a. identifying, within a current XSL-FO area tree, or refined XSL-FO area tree, a current line area, corresponding to a current line object, of a current block area, corresponding to a current block object of the area tree;
b. determining a characteristic associated with the current line area;
c. matching the characteristic with a common characteristic at least one or more consecutive line areas;
d. creating a group block area comprising the current line area and at least one or more consecutive line areas such that lines of text, derived from the current line area and at least one or more consecutive line areas, constituting the group block area possess the common characteristic to produce at least an output document area.

7. A method as claimed in claim 1, further comprising the step of rendering the or a current output document area.

8. A method as claimed in claim 1 in which the common characteristic is at least one of a common XML or XML-FO element, an XML or XML-FO attribute-value pair such as, for example, style=“font-family:Times”, property or trait.

9. A system comprising means to implement a method as claimed claim 1.

10. A computer program comprising computer code to implement a method or system as claimed in claim 1.

11. A computer readable product comprising storage storing a computer program as claimed in claim 10.
